(19) United States
(12) Patent Application Publication
(10) Pub. No.: US 2026/0060335 A1
(43) Pub. Date: Mar. 5, 2026

(54) METHOD FOR CLEANING AEROSOL-GENERATING DEVICE, AEROSOL-GENERATING DEVICE, AND SUBSTRATE

(71) Applicant: SMOORE INTERNATIONAL HOLDINGS LIMITED, George Town (KY)

(72) Inventors: Lei MA, Shenzhen (CN); Pengchong ZHANG, Shenzhen (CN); Xianwu DU, Shenzhen (CN); Hengheng DOU, Shenzhen (CN); Xiangzhong LI, Shenzhen (CN); Rihong LI, Shenzhen (CN); Hongming ZHOU, Shenzhen (CN); Shiyuan LIU, Shenzhen (CN)

(21) Appl. No.: 19/383,615

(22) Filed: Nov. 8, 2025

Related U.S. Application Data
(63) Continuation of application No. PCT/CN2024/091481, filed on May 7, 2024.

(30) Foreign Application Priority Data
May 9, 2023 (CN) 202310520802.4

(51) Int. Cl. A24F 40/85; A24F 40/20; A24F 40/46; A24F 40/53; A24F 40/57

(52) U.S. Cl. CPC A24F 40/85; A24F 40/46; A24F 40/53; A24F 40/57; A24F 40/20

(57) ABSTRACT

A method for cleaning an aerosol-generating device having a heating structure for heating an aerosol-forming substrate at an operating temperature includes: monitoring whether the aerosol-forming substrate is inserted into or extracted from the aerosol-generating device; and when the aerosol-forming substrate is extracted, setting a temperature of the heating structure to a self-cleaning temperature not exceeding the operating temperature so as to heat and release a material adhered to or deposited on the heating structure.

### CROSS-REFERENCE TO PRIOR APPLICATION

This application is a continuation of International Patent Application No. PCT/CN2024/091481, filed on May 7, 2024, which claims priority to Chinese Patent Application No. 202310520802.4, filed on May 9, 2023. The entire disclosure of both applications is hereby incorporated by reference herein.

### FIELD

The present invention relates to the field of heat-not-burn technology, and in particular to a method for cleaning an aerosol-generating device, an aerosol-generating device, and a substrate.

### BACKGROUND

Heat-not-burn cigarettes, also known as low-temperature cigarettes or new type cigarettes, are mainly characterized by heating tobacco with an external heat source instead of igniting the tobacco. Because a heating temperature is much lower than a burning temperature, harmful components generated by thermal cracking and thermal synthesis of tobacco by high-temperature burning can be effectively reduced, and the amount of chemical components in mainstream aerosol released is greatly reduced.

A low-temperature, inserted heating cigarette-type device is a relatively common form. Typically, a long, strip-shaped heater is inserted into an aerosol-forming substrate having a form similar to that of a common cigarette, to heat an aerosol forming material. However, because the aerosol forming material is prepared from a natural tobacco leaf composition and/or other aerosol forming materials, a small amount of oil-like liquid materials including tar may spill out during a heating process, and these liquid materials may remain on an accommodating cavity of the aerosol-forming substrate and the heater of the device. If the liquid materials are not removed in time, a deposit may be formed during repeated use, the heating performance of the heater may be affected, and a smell material may be generated when the liquid materials are cracked, greatly affecting the flavor experience of subsequent inhalations.

Therefore, timely removal of the tobacco tar from a heating element is greatly beneficial to improving energy efficiency, enhancing flavor experience, and maintaining hygiene. However, a matched cleaning tool is substantially used to perform cleaning in the prior art, which is complicated and inconvenient in operation.

An existing patent US2015282525A1 discloses a method and device for cleaning a heating structure of an aerosol-generating device. According to the method, the temperature of the heating structure is increased to a second temperature higher than a first temperature, so that an organic material adhered to or disposed on the heating structure is released by heat, and the organic material is charred and pyrolyzed by high temperature, thereby achieving a desirable cleaning effect on a heating element. However, the heating element of the aerosol-generating device needs to be heated to a temperature higher than a temperature at which the heating element heats the aerosol-forming substrate, and a self-cleaning temperature of the heating element needs to be higher than an operating temperature at which the heating element bakes the aerosol-forming substrate. On one hand, this design is not beneficial for energy saving and is complex in temperature control. On the other hand, to bear a higher temperature, the heat resistance of the heating element and the heat insulation of the device need to be further improved, and such design wastes relatively much and costs high.

### SUMMARY

In an embodiment, the present invention provides a method for cleaning an aerosol-generating device having a heating structure for heating an aerosol-forming substrate at an operating temperature, the method comprising: S10: monitoring whether the aerosol-forming substrate is inserted into or extracted from the aerosol-generating device; and S20: when the aerosol-forming substrate is extracted, setting a temperature of the heating structure to a self-cleaning temperature not exceeding the operating temperature so as to heat and release a material adhered to or deposited on the heating structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a flowchart of an embodiment of a method of the present invention;

FIG. 2 shows a flowchart of some embodiments of a method of the present invention;

FIG. 3 shows a self-cleaning temperature curve of some embodiments of a method of the present invention;

FIG. 4 shows a self-cleaning temperature curve of some embodiments of a method of the present invention;

FIG. 5 shows a flowchart of some embodiments of a method of the present invention;

FIG. 6 is a schematic diagram showing the overall structure of an embodiment of an aerosol-generating device according to the present invention;

FIG. 7 shows a temperature control curve for heating an aerosol-forming substrate in some embodiments of the present invention;

FIG. 8 shows a schematic structural diagram of a heating structure in the aerosol-generating device as shown in FIG. 6;

FIG. 9 shows a sectional view of the heating structure as shown in FIG. 8;

FIG. 10 shows a schematic exploded view of the heating structure as shown in FIG. 8;

FIG. 11 shows a schematic structural diagram of the heating structure of the aerosol-generating device in an embodiment of the present invention;

FIG. 12 shows a schematic structural diagram of the heating structure as shown in FIG. 11 from another perspective;

FIG. 13 shows a sectional view of the heating structure as shown in FIG. 11;

FIG. 14 shows a schematic exploded view of the heating structure as shown in FIG. 11; and

FIG. 15 shows a cross-sectional view of a heating element in an embodiment of the present invention.

### DETAILED DESCRIPTION

In an embodiment, the present invention provides a method for cleaning an aerosol-generating device, an aerosol-generating device, and a substrate.

In an embodiment, the present invention provides a method for cleaning an aerosol-generating device, where the aerosol-generating device includes a heating structure, the heating structure is capable of heating an aerosol-forming substrate at an operating temperature, and the method includes the following steps:
S10: monitoring whether the aerosol-forming substrate is inserted into or extracted from the aerosol-generating device; and
S20: when the aerosol-forming substrate is extracted, setting the temperature of the heating structure to a self-cleaning temperature that does not exceed the operating temperature, for heating and releasing a material adhered to or deposited on the heating structure.

Further, in the method for cleaning an aerosol-generating device, step S20 includes:
S21: when the aerosol-forming substrate is extracted, setting the temperature of the heating structure to the self-cleaning temperature that does not exceed the operating temperature according to a user's input instruction, and heating the material by infrared radiation for releasing the material.

Further, in the method for cleaning an aerosol-generating device, step S21 includes:
initiating a first heating mode of the heating structure according to the user's input instruction, for rapidly increasing the temperature of the heating structure to the self-cleaning temperature that does not exceed the operating temperature; and
when the temperature of the heating structure reaches the self-cleaning temperature, adjusting the heating mode of the heating structure, and heating the material by infrared radiation for releasing the material.

Further, in the method for cleaning an aerosol-generating device, the user's input instruction is at least one of a mechanical key instruction, a touch key instruction, and a voice instruction.

Further, in the method for cleaning an aerosol-generating device, step S20 includes:
S22: determining whether the aerosol-generating device reaches a preset cleaning condition when the aerosol-forming substrate is extracted; and
S23: if the aerosol-generating device reaches the preset cleaning condition, setting the temperature of the heating structure to the self-cleaning temperature that does not exceed the operating temperature, and heating the material by infrared radiation for releasing the material.

Further, in the method for cleaning an aerosol-generating device, step S23 includes:
when the aerosol-generating device reaches the preset cleaning condition, initiating a first heating mode of the heating structure, for rapidly increasing the temperature of the heating structure to the self-cleaning temperature that does not exceed the operating temperature; and
when the temperature of the heating structure reaches the self-cleaning temperature, adjusting the heating mode of the heating structure, and heating the material by infrared radiation for releasing the material.

Further, in the method for cleaning an aerosol-generating device, the preset cleaning condition is that the light transmittance of a tube of the heating structure is less than a preset threshold; or the preset cleaning condition is that the luster or the color of the outer wall of the tube of the heating structure is in a preset color system.

Further, in the method for cleaning an aerosol-generating device, the preset cleaning condition is that the number of aerosol-forming substrates consumed by a user reaches a preset number; or
the preset cleaning condition is that the number of times the aerosol-forming substrates disengages from the heating structure reaches a preset number of times; or
the preset cleaning condition is the heating time accumulated since the last cleaning of the heating structure.

Further, in the method for cleaning an aerosol-generating device, the first heating mode is heating at a first preset power for a first preset duration; and
the adjusting the heating mode of the heating structure includes:
adjusting the first heating mode to at least one of: heating at a constant power for a second preset duration, heating at a variable power for a second preset duration, and pulse heating for a second preset duration.

Further, in the method for cleaning an aerosol-generating device, the self-cleaning temperature is between 400° C. and 550° C.

In addition, the present invention further provides a computer storage medium, storing therein a computer program, which, when executed by a processor, implements the steps of the aforementioned method for cleaning an aerosol-generating device.

In addition, the present invention further provides an aerosol-generating device, including a processor and a memory storing a computer program, where the processor, when executing the computer program, implements the steps of the aforementioned method for cleaning the aerosol-generating device.

Further, in the aerosol-generating device according to the present invention, a heating structure of the aerosol-generating device includes a heating element and a tube, where the heating element includes a heating substrate and an infrared radiation layer arranged on the outer surface of the heating substrate, the heating substrate is configured to be electrically heated to excite the infrared radiation layer to radiate infrared light, the heating element is arranged at least partially spaced apart from the wall of the tube, the wall of the tube allows the infrared light to transmit through, and the infrared light is used for heating an aerosol-forming substrate.

Further, in the aerosol-generating device according to the present invention, the heating element is located in the tube, and
at least a part of the tube is configured for insertion of the aerosol-forming substrate.

Further, in the aerosol-generating device according to the present invention, the heating element is located outside the tube, an accommodating cavity is formed in the tube, and the accommodating cavity is used for accommodating at least a part of the aerosol-forming substrate.

Further, in the aerosol-generating device according to the present invention, the heating structure of the aerosol-generating device is a plasma heating structure.

By implementing the method for cleaning an aerosol-generating device, the aerosol-generating device, and the substrate according to the present invention, the following beneficial effects are obtained: By using the heat characteristic of the self-heating element of the aerosol-generating device, without additionally increasing the operating temperature, the tobacco tar adhered to or deposited on the heating structure can be removed in a timely manner, thereby significantly improving energy efficiency, enhancing flavor experience, and maintaining device hygiene, and the temperature control logic is simple.

To provide a clearer understanding of the technical features, objectives, and effects of the present invention, specific implementations of the present invention are described in detail with reference to the accompanying drawings.

In the following description, for the purpose of description rather than limitation, concrete details such as the specific system structure and technology are provided to thoroughly understand embodiments of the present invention. However, those skilled in the art should be aware that the present invention may also be implemented in other embodiments without these concrete details. In other cases, detailed descriptions of well-known systems, devices, circuits, and methods are omitted to avoid unnecessary details hindering the description of the present invention.

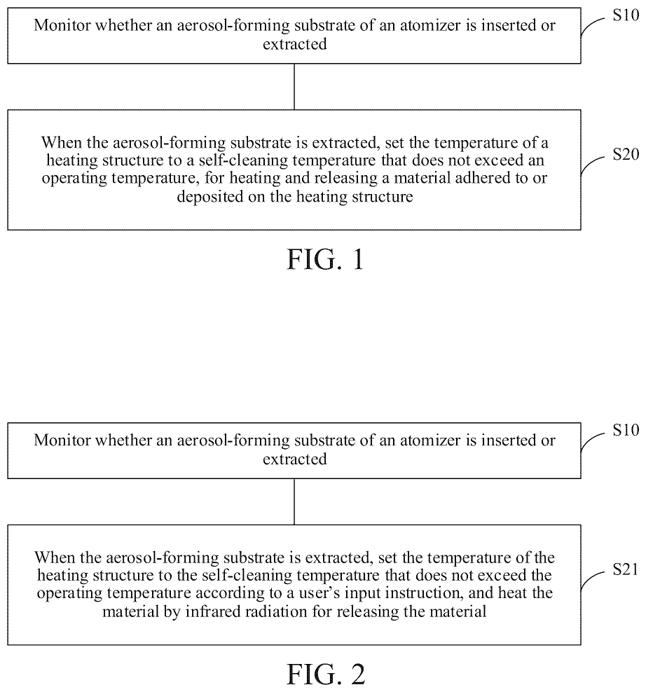

In an exemplary embodiment, referring to FIG. 1, an aerosol-generating device in this embodiment includes a heating structure, the heating structure is capable of heating an aerosol-forming substrate at an operating temperature, and a method for cleaning an aerosol-generating device includes the following steps:
S10: Monitor whether the aerosol-forming substrate is inserted into or extracted from the aerosol-generating device. S20: When the aerosol-forming substrate is extracted, set the temperature of the heating structure to a self-cleaning temperature that does not exceed an operating temperature, for heating and releasing a material adhered to or deposited on the heating structure, i.e., evaporating an organic material in the form of an aerosol or gas. A heating element of the heating structure may be in a plurality of forms, for example, a heating sheet, a heating pin, a heating rod, or a heating line or wire. Alternatively, the heating element may be a combination of two or more of the above heating components in different forms. The heating element is covered with a tube, e.g., a quartz glass tube, that allows infrared light to transmit through.

The aerosol-forming substrate may be a filamentous, sheet-like, or integrally formed solid material made from leaves and/or stems of plants (e.g., tobacco), and an aroma component may be further added to the solid material.

Preferably, the operating temperature may be a temperature range, and the self-cleaning temperature does not exceed the maximum value of a preset range of the operating temperature.

The working principle of the present invention is: without the aerosol-forming substrate, filth on the surface of the heating structure of the aerosol-generating device is heated and decomposed at a high temperature to achieve self-cleaning. Without the aerosol-forming substrate, the heating temperature of the outer wall of the quartz tube of the heating structure is 400-550° C. for 3-30 s. During normal operation of the aerosol-generating device with the aerosol-forming substrate, the maximum local temperature on the external surface of the heating structure may reach about 550° C. This can not only prevent the substrate from burning but also can ensure a satisfying flavor experience.

The operating temperature is a group of temperatures that vary with time, and has the maximum temperature. Within a period of time during which the aerosol-forming substrate is heated to form an aerosol, the substrate is mainly heated by light wave radiation. Namely, the heating rate of the aerosol-forming substrate is high. However, because a temperature reduction process of light wave infrared heating is fast, and the operating temperature lasts for a short period of time, the substrate heated by light wave infrared radiation cannot get burnt.

Optionally, in a high-temperature cleaning period, after the aerosol-forming substrate is extracted, cleaning can be achieved as long as the quartz tube keeps the maximum operating temperature without needing to reach a self-cleaning temperature that is higher than all the operating temperatures.

Optionally, in the high-temperature cleaning period, the temperature at which an organic material adhered to the heating structure is released may also not need to reach the maximum operating temperature. Assuming that the maximum operating temperature is 550° C., the temperature at which the organic material adhered to the heating structure is released only needs to be higher than 400° C. Therefore, the self-cleaning temperature may be between 400° C. and 550° C., or between 400° C. and 430° C.

In this embodiment, the tobacco tar adhered to or deposited on the heating structure can be removed in a timely manner, thereby significantly improving energy efficiency, enhancing flavor experience, and maintaining device hygiene.

In the method for cleaning an aerosol-generating device in some embodiments, referring to FIG. 2, the cleaning mode of the aerosol-generating device may be a manual mode. Namely, S21: when the aerosol-forming substrate is extracted, the temperature of the heating structure is set to the self-cleaning temperature that does not exceed the operating temperature according to a user's input instruction, and the material is heated by infrared radiation for releasing or evaporating the material.

Optionally, a first heating mode of the heating structure is initiated according to a user's input instruction, for rapidly increasing the temperature of the heating structure to the self-cleaning temperature that does not exceed the operating temperature. When the temperature of the heating structure reaches the self-cleaning temperature, the heating mode of the heating structure is adjusted, and the material is heated by infrared radiation for releasing the material. Optionally, the user's input instruction may be, but is not limited to a mechanical key instruction, a touch key instruction, a voice instruction, or the like. It should be noted that the “rapidly increasing the temperature” as described above is relative to the related prior art, and the preheating time in the related prior art is typically about 15 s. Therefore, in the present invention, a heating rate of 10 s or less may be understood as “rapid”, and is preferably within 6 s.

Specifically, the first heating mode is heating at a first preset power (e.g., a high power) for a first preset duration. The adjusting the heating mode of the heating structure includes: adjusting the first heating mode to: heating at a constant power for a second preset duration, heating at a variable power for a second preset duration, and pulse heating for a second preset duration. It should be noted that the high power is relative to a heating power range of the aerosol-generating device. For example, if the heating power range of the aerosol-generating device is 2-30 W, then the high power may be 5 W, 10 W, 15 W, 18 W, 20 W, 22 W, 25 W, 30 W, or the like, which is specifically set according to specific requirements. The aerosol-generating device may adjust the heating mode of the heating structure according to pre-stored preset experience. Namely, when the heating time of the first heating mode reaches a particular duration, the first heating mode of the heating structure is converted into a second heating mode which is maintained for a particular duration. For example, the preset experience is that the temperature of the heating structure can reach the self-cleaning temperature when the heating structure is heated at a high power for 3 s. Therefore, when the heating structure is heated at a high power for 3 s, the heating mode is switched to heating at a variable power for 10 s. According to the experience, all organic materials adhered to the aerosol-generating device can be released by heating at a variable power for 10 s.

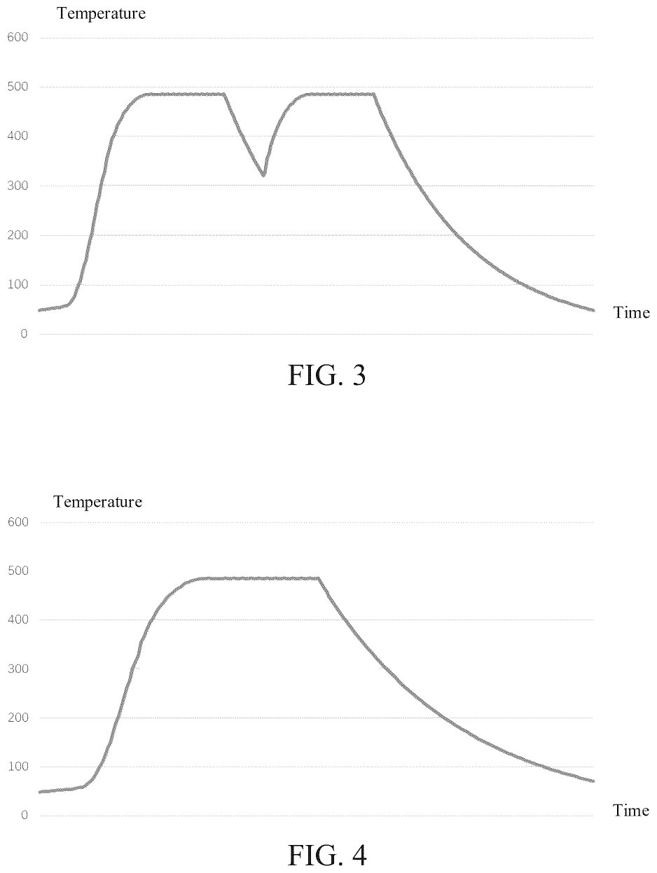

Exemplarily, an “On/off” button and a “Self-cleaning” function button may be provided for the aerosol-generating device. The “Self-cleaning” function button is not necessarily provided, and may be replaced with a different pressing manner of the “On/off” button. For example, the “On/off” button is pressed for a short time to switch on the aerosol-generating device to enter a standby mode; the “On/off” button is pressed again for a short time to query the state of the aerosol-generating device; and the “On/off” button is pressed for a long time, for example, for 3 s, to enable the aerosol-generating device to enter a normal operating mode, to heat the aerosol-forming substrate, and vice versa. If the surface of the heating structure has filth, the “Self-cleaning” button is pressed (or the “On/off” button is double-clicked), to enable the aerosol-generating device to enter the self-cleaning operating mode. After the aerosol-forming substrate is extracted, the heating structure is heated at a high power (in a range of 2-30 W) continuously by the aerosol-generating device, to make the temperature of a heating wire of the heating structure reach 600-1200° C., and the corresponding temperature of the outer wall of the quartz tube is 400-550° C. A stable power output is maintained to maintain the temperature of the quartz tube of the heating structure to 400° C. or higher for 3-30 s. As shown in FIG. 3 and FIG. 4, in this period of time, heating at a constant high power, pulse heating, heating at a variable power, or the like may be performed. Optionally, in the heating process, heating may be performed for a period of time first, then discontinued for a period of time, and then continued for a period of time; or repeated periodical heating may be performed; or continuous uninterrupted heating may be performed. Namely, as shown in FIG. 3, in a constant-power heating mode, the self-cleaning temperature may be maintained at a temperature value in a range of 400-550° C. for continuous heating. After the self-cleaning operating mode ends, the aerosol-generating device enters a standby mode or is automatically off.

In this embodiment, by a semi-automatic cleaning mode via a user's input instruction, the tobacco tar adhered to or deposited on the heating structure can be removed in a timely manner, thereby significantly improving energy efficiency, enhancing flavor experience, and maintaining device hygiene, and providing convenience in use.

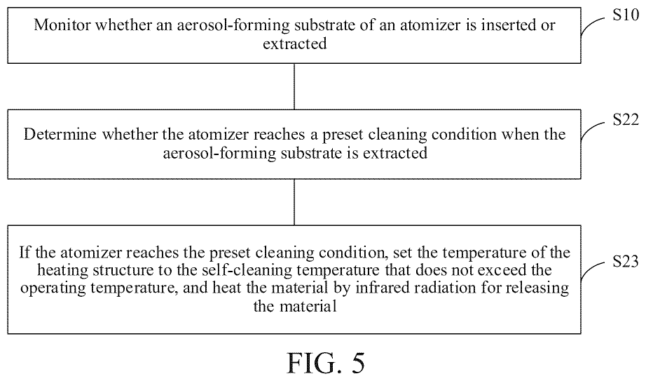

In the method for cleaning an aerosol-generating device in some embodiments, referring to FIG. 5, the cleaning mode of the aerosol-generating device may also be a fully-automatic mode. Namely,
S22: Determine whether the aerosol-generating device reaches a preset cleaning condition when the aerosol-forming substrate is extracted. S23: If the aerosol-generating device reaches the preset cleaning condition, set the temperature of the heating structure to the self-cleaning temperature that does not exceed the operating temperature, and heat the material by infrared radiation for releasing the material.

Optionally, when the aerosol-generating device reaches the preset cleaning condition, a first heating mode of the heating structure is initiated, for rapidly increasing the temperature of the heating structure to the self-cleaning temperature that does not exceed the operating temperature. When the temperature of the heating structure reaches the self-cleaning temperature, the heating mode of the heating structure is adjusted, and the material is heated by infrared radiation for releasing the material. Or, when the aerosol-generating device reaches the preset cleaning condition, and residual heat left at the original operating temperature can sufficiently reach the self-cleaning temperature, the first heating mode of the heating structure needs not to be enabled, and the heating mode of the heating structure may be directly adjusted, and the material is heated by infrared radiation for releasing the material.

Specifically, the first heating mode is heating at a first preset power (e.g., a high power) for a first preset duration. The adjusting the heating mode of the heating structure includes: adjusting the first heating mode to: heating at a constant power for a second preset duration, heating at a variable power for a second preset duration, and pulse heating for a second preset duration. It should be noted that the high power is relative to a heating power range of the aerosol-generating device. For example, if the heating power range of the aerosol-generating device is 2-30 W, then the high power may be 15 W, 18 W, 20 W, 22 W, 25 W, 30 W, or the like, which is specifically set according to specific requirements. The aerosol-generating device may adjust the heating mode of the heating structure according to pre-stored preset experience. Namely, when the heating time of the first heating mode reaches a particular duration, the first heating mode of the heating structure is converted into a second heating mode which is maintained for a particular duration. For example, the preset experience is that the temperature of the heating structure can reach the self-cleaning temperature when the heating structure is heated at a high power for 3 s. Therefore, when the heating structure is heated at a high power for 3 s, the heating mode is switched to heating at a variable power for 10 s. According to the experience, all organic materials adhered to the aerosol-generating device can be released by heating at a variable power for 10 s.

Optionally, the preset cleaning condition may be that the light transmittance of the tube of the heating structure is less than a preset threshold or a first preset range; or the preset cleaning condition may be that the luster or the color of the outer wall of the tube of the heating structure is in a preset color system. The preset color system refers to that the aerosol-generating device automatically detects whether the luster or the color of the outer wall of the tube falls within a pre-stored color gamut range. For example, assuming that the color of the outer wall detected is dark brown that belongs to the dark color range, cleaning needs to be performed or more intensive cleaning is needed, for example, setting a longer cleaning duration; and if the color of the outer wall is light brown that belongs to a light color range, cleaning needs not to be performed or less intensive cleaning is needed, for example, setting a shorter cleaning duration, and the like. The preset cleaning condition may be that the number of aerosol-forming substrates consumed by a user reaches a preset number; or the preset cleaning condition may be that the number of times the aerosol-forming substrates disengages from the heating structure reaches a preset number of times; or the preset cleaning condition may be the heating time accumulated since the last cleaning of the heating structure. Further, the heating time and/or the heating mode at the self-cleaning temperature may be automatically determined according to the level of related parameters detected. For example, when the light transmittance of the tube of the heating structure is 50% of the original light transmittance, the aerosol-generating device automatically adjusts the heating time at the self-cleaning temperature to 5 s, indicating that a specific cleaning intensity is needed; when the light transmittance of the tube of the heating structure is 30% of the original light transmittance, the aerosol-generating device automatically adjusts the heating time at the self-cleaning temperature to 10 s or longer, indicating that there is much filth on the surface of the heating structure, and a more intensive cleaning is needed, and so on.

In this embodiment, by the fully-automatic cleaning mode, the tobacco tar adhered to or deposited on the heating structure can be removed in a timely manner, thereby significantly improving energy efficiency, enhancing flavor experience, and maintaining device hygiene. The diversity of options for cleaning the aerosol-generating device is increased, and user experience is improved.

In another exemplary embodiment, a computer storage medium of this embodiment stores therein a computer program, which, when executed by a processor, implements the steps of the aforementioned method for cleaning an aerosol-generating device.

The computer-readable storage medium of the present invention may be various computer-readable storage media that can store program code, such as USB flash drives, portable hard drives, read-only memory (ROM), magnetic disks, or optical disks.

In another exemplary embodiment, an aerosol-generating device of this embodiment includes a processor and a memory for storing a computer program, where the processor, when executing the computer program, implements the steps of the aforementioned method for cleaning the aerosol-generating device.

The processor of the present invention is configured to provide computing and control capabilities to support operation of the entire heat-not-burn device.

It should be understood that, in the embodiments of the present application, the processor may be a central processing unit (CPU), or the processor may be a general-purpose processor, a digital signal processor (DSP), an application specific integrated circuit (ASIC), a field programmable gate array (FPGA), a programmable logic device, a discrete gate, a transistor logic device, a discrete hardware component, or the like. The general-purpose processor may be a microprocessor, or the processor may be any conventional processor, or the like.

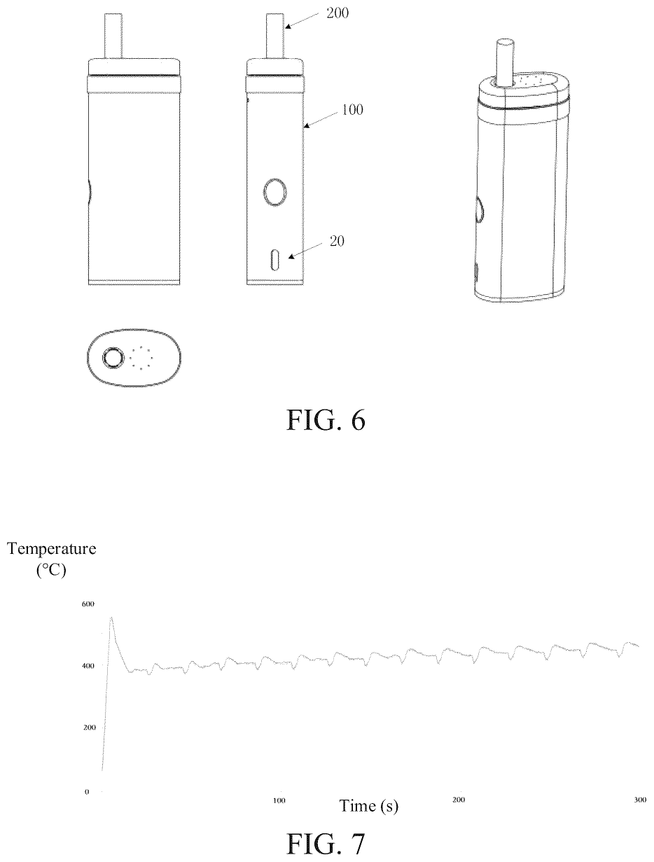

FIG. 6 is a schematic diagram showing the overall structural of an embodiment of the aerosol-generating device according to the present invention. The aerosol-generating device 100 of this embodiment may heat an aerosol-forming substrate 200 in a low-temperature heat-not-burn manner, and has good stability and flavor experience. In some applications, the aerosol-forming substrate 200 is removably arranged the aerosol-generating device 100, and the aerosol-forming substrate 200 may be cylindrical in shape. Specifically, the aerosol-forming substrate may be a filamentous, sheet-like, or integrally formed solid material made from leaves and/or stems of plants (e.g., tobacco), and an aroma component may be further added to the solid material.

In this embodiment, the tobacco tar adhered to or deposited on the heating structure can be removed in a timely manner, thereby significantly improving energy efficiency, enhancing flavor experience, and maintaining device hygiene. The diversity of options for cleaning the aerosol-generating device is increased, and user experience is improved.

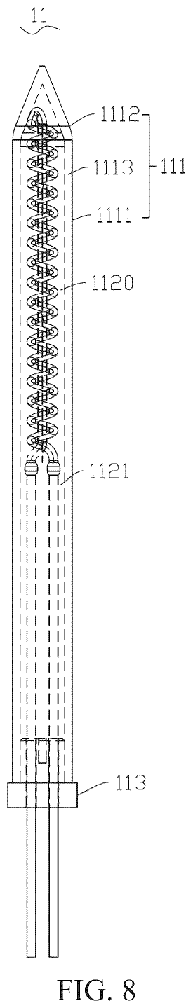

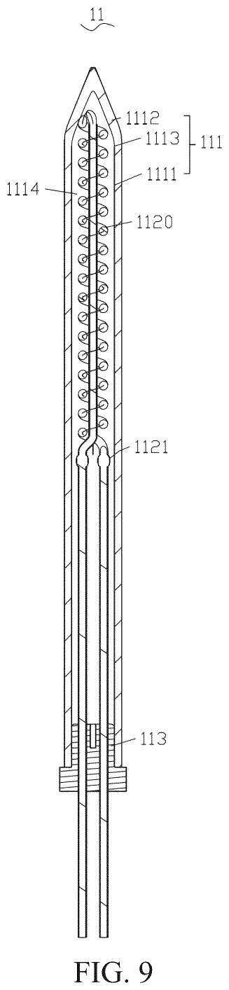

In the aerosol-generating device in some embodiments, as shown in FIG. 6 and FIG. 8, the aerosol-generating device 100 in this embodiment includes a heating structure 11 and a power supply component 20. The heating structure 11 may be partially inserted into the aerosol-forming substrate 200, and specifically, the heating structure may be partially inserted into a substrate section of the aerosol-forming substrate 200, and generate infrared light in a powered-on state to heat the substrate section of the aerosol-forming substrate 200 to generate an aerosol. The heating structure 11 has the advantages of simple structure, high heating and aerosol forming efficiency, high stability, and long service life. The power supply component 20 is used to supply power to the heating structure 11. Specifically, in some applications, the heating structure 11 is detachably mounted in a shell of the power supply component 20, and may be mechanically and/or electrically connected to a power supply in the power supply component 20. By mounting the heating structure 11 detachably in the shell of the power supply component 20, the replacement of the heating structure 11 is facilitated.

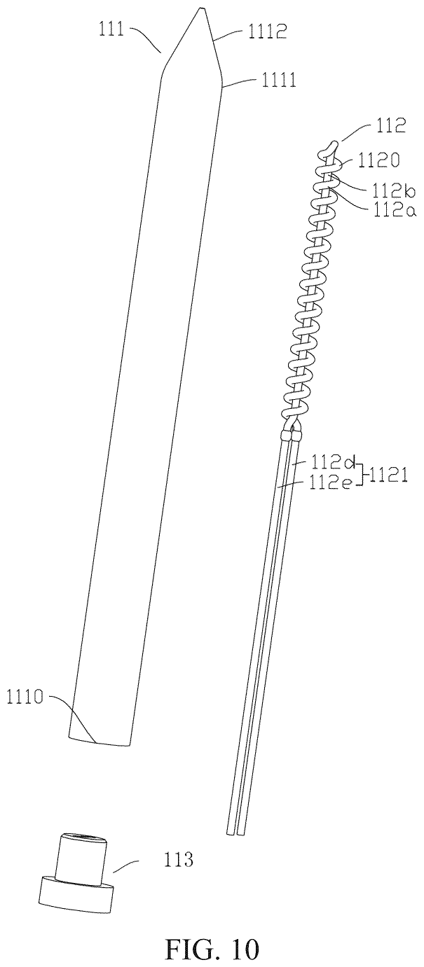

As shown in FIG. 8 and FIG. 10, in this embodiment, the heating structure 11 includes a tube 111, a heating element 112, and a base 113. The tube 111 encloses at least a part of the heating element 112, and allows light waves to transmit through to the aerosol-forming substrate 200. Specifically, in this embodiment, the tube 111 allows infrared light to transmit through, thereby facilitating the transmission of infrared radiation from the heating element 112 to heat the aerosol-forming substrate 200. The base 113 is arranged at an opening 1110 of the tube 111, and is used to fix the tube 111 or seal the opening 1110 of the tube 111. The heating element 112 may be in a plurality of forms, for example, a heating sheet, a heating pin, a heating rod, or a heating line or wire. Alternatively, the heating element 112 may be a combination of two or more of the above heating components in different forms. The cross section of the tube 111 may be circular, triangular, or elliptical, or may be of any other shape.

It should be noted that, an operating temperature of the heating structure refers to a heating temperature of the tube 111, or an average temperature of the tube 111 in the heating process, or the highest local temperature of the tube 111 in the heating process.

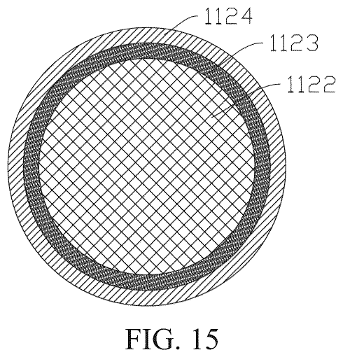

In some embodiments, referring to FIG. 8, FIG. 10, and FIG. 15, the heating element 112 includes a heating part 1120 and a conductive part 1121. The heating part 1120 includes a heating substrate 1122 and an infrared radiation layer 1124 wrapping the heating substrate 1122. Namely, the infrared radiation layer 1124 is arranged on the outer surface of the heating substrate 1122. The heating substrate 1122 is electrically heated according to the aforementioned cleaning method, and in the electrically heated state, the heating substrate 1122 may excite the infrared radiation layer 1124 to generate and radiate infrared light. Optionally, the heating element 112 is located in the tube 111, and at least a part of the tube 111 is configured for insertion of the aerosol-forming substrate. Or, the heating element 112 is located outside the tube 111, an accommodating cavity is formed in the tube 111, and the accommodating cavity is configured to accommodate at least a part of the aerosol-forming substrate.

Specifically, the heating substrate 1122 includes a metal substrate having high-temperature oxidation resistance, for example, a metal wire. The heating substrate 1122 may be a nickel-chromium alloy substrate (e.g., a nickel-chromium alloy wire), an iron-chromium-aluminum alloy substrate (e.g., an iron-chromium-aluminum alloy wire), or the like made of a metal material having good high-temperature oxidation resistance, high stability, good deformation resistance, and the like. In some embodiments, the diameter of the metal wire may be 0.15-0.8 mm. The metal wire may be bent or wound into different shapes, for example, a spiral, mesh, M, or N shape. The bent or wound heating element 112 has a generally cylindrical, sheet-like, barrel-like, spiral, or mesh shape, or other three-dimensional bent shapes or planar shapes.

In a specific implementation, the heating element 112 is in the shape of a strip having a circular cross section. The heating element 112 is at least partially bent to form a generally cylindrical heating part 1120. Specifically, the heating element 112 may be bent to form a spiral cylindrical heating part 1120. A substrate for forming the heating substrate may be selected to form the heating substrate 1122. For example, a metal wire (e.g., a nickel-chromium alloy wire or an iron-chromium-aluminum alloy wire) for infrared light waves is selected to form the heating substrate 1122, and the metal wire is wound to form the heating part 1120 having a single-spiral shape. Of course, it can be understood that, in some other embodiments, the heating element 112 is not limited to the heating part 1120 wound in the single-spiral shape, and the heating element 112 may be wound in different manners to form a double-spiral, M, or N shape.

Preferably, referring to FIG. 15, the heating element 112 further includes an anti-oxidation layer 1123, and the anti-oxidation layer 1123 is formed between the heating substrate 1122 and the infrared radiation layer 1124. Specifically, the anti-oxidation layer 1123 may be an oxide film, a layer of dense oxide film that is generated on the surface of the heating substrate 1122 subjected to high-temperature heat treatment, and the oxide film is the anti-oxidation layer 1123. Of course, it can be understood that, in some other embodiments, the anti-oxidation layer 1123 is not limited to the oxide film formed on the heating substrate 1122. In some other embodiments, the anti-oxidation layer 1123 may be an anti-oxidation coating applied to the outer surface of the heating substrate 1122. The thickness of the anti-oxidation layer 1123 may be optionally 1-150 um.

Optionally, the infrared radiation layer 1124 may be an infrared layer. The infrared layer may be an infrared layer-forming substrate that is formed by high-temperature heat treatment on the side of the anti-oxidation layer 1123 away from the heating substrate 1122. Specifically, the infrared layer-forming substrate may be silicon carbide, spinel, or a composite substrate thereof. Of course, it can be understood that, in some other embodiments, the infrared radiation layer 1124 is not limited to the infrared layer. In some other embodiments, the infrared radiation layer 1124 may be a composite infrared layer. Specifically, the infrared layer may be formed by dip coating, spray coating, brush coating, or the like on the side of the anti-oxidation layer 1123 away from the heating substrate 1122. The thickness of the infrared radiation layer 1124 may be 10-300 um.

Further, the wall of the tube 111 is arranged spaced apart from the entire heating element 112. For example, a gap 1114 is reserved between the tube 111 and the heating element 112, and the gap 1114 may be filled with air. Of course, it can be understood that, in some other embodiments, the gap 1114 may be filled with a reducing gas or an inert gas. Due to the gap 1114, the tube 111 and the heating element 112 are not in direct contact. In some embodiments, the heating element 112 may also be arranged partially spaced apart from the wall of the tube 111. Specifically, the radial dimension of one section of the heating part 1120 may be greater than the radial dimension of another section, and the radial dimension of the section of the heating part 1120 may be equal to the inner diameter of the tube 111, to achieve a position limiting effect. Of course, it can be understood that, in some embodiments, the inner side of the tube 111 may be partially protruded toward the heating element 112 and in contact with the heating element 112, to achieve a position limiting effect. Of course, it can be understood that, in some other embodiments, an isolating and positioning structure may be arranged on the heating element 112 or the wall of the tube 111, so that the heating element 112 is not in direct contact with the wall of the tube 111. For example, a section of the heating element 112 is sheathed with a ceramic ring or the like. It should be noted that the gap mentioned above may be a gap accessible to air, but this does not necessarily imply the presence of air or other gases, and the gap may also be in a vacuum state. To obtain a better sensory experience and prolong the service life of the heating element, the tube 111 may be in a vacuum state or sealed at its open end.

Further, the heating part 1120 includes a first heating part 112a and a second heating part 112b; and one end of the first heating part 112a is connected to one end of the second heating part 112b. The first heating part 112a and the second heating part 112b are of an integrally formed structure, and may be formed by bending one heating element 112. It can be understood that, in some other embodiments, the first heating part 112a and the second heating part 112b may also be of a split structure, and the first heating part 112a and the second heating part 112b may be two heating elements 112. It can be understood that, in some other embodiments, the second heating part 112b may also be omitted, and be replaced with a non-heating conductive rod. In addition, the conductive part 1121 may be welded to the heating part 1120 fixedly. Of course, it can be understood that, in some other embodiments, the heating part 1120 may be integrally formed with the conductive part 1121. A first free end 112d and a second free end 112e of the heating element 112 may form two conductive parts 1121 separately. Namely, the first free end 112d of the first heating part 112a forms one conductive part 1121; and the second free end 112e of the second heating part 112b forms the other conductive part 1121. In some other embodiments, the conductive part 1121 may be a lead wire that may be welded to the heating part 1120. Of course, it can be understood that, in some other embodiments, the conductive part 1121 is not limited to the lead wire, and may be other conductive structures.

Optionally, the tube 111 may be a quartz glass tube. Of course, it can be understood that, in some other embodiments, the tube 111 is not limited to the quartz tube, and may be made of other window materials that allow light waves to transmit through, for example, infrared transmitting glass, transparent ceramics, and diamond.

Further, the tube 111 is of a hollow tubular structure and has two ends distributed axially. Specifically, the tube 111 includes a main part 1111 and a pointed part 1112 formed at one end of the main part 1111, and the heating element 112 is arranged spaced apart from the inner wall of the main part 1111. Of course, it can be understood that, in some other embodiments, the cross section of the tube 111 is not limited to a circular shape. The main part 1111 is a hollow structure with an opening 1110 at one end. The pointed part 1112 is formed at one end of the main part 1111 away from the opening 1110. By providing the main part 1111, at least a part of the heating structure 11 may be inserted into or extracted from the aerosol-forming substrate 200 conveniently. In this embodiment, a first accommodating cavity 1113 is formed inside the tube 111, and the first accommodating cavity 1113 is a cylindrical cavity. In some other embodiments, the heating element 112 may be arranged around the outer circumference of the tube 111 with a spacing in between, and a second accommodating cavity for accommodating the aerosol-forming substrate 200 may be formed inside the tube 111.

Further, the wall of the tube 111 is arranged spaced apart from the entire heating element 112. For example, a gap 1114 is reserved between the tube 111 and the heating element 112, and the gap 1114 may be filled with air. Of course, it can be understood that, in some other embodiments, the gap 1114 may be filled with a reducing gas or an inert gas. Due to the gap 1114, the tube 111 and the heating element 112 are not in direct contact. In some embodiments, the heating element 112 may also be arranged partially spaced apart from the wall of the tube 111. Specifically, a conductive part 1121 is arranged at one end of the heating part 1120. The conductive part 1121 is connected to the heating part 1120, may be led out from one end of the tube 111, and may penetrate through the base 113 and be conductively connected to the power supply component 20. The radial dimension of one section of the heating part 1120 may be greater than the radial dimension of another section, and the radial dimension of the section of the heating part 1120 may be equal to the inner diameter of the tube 111, to achieve a position limiting effect.

Preferably, at least a part of the top of the heating element 112 is in contact with the inner wall surface of the pointed part 1112. In this way, the end of the heating element 112 close to the pointed part 1112 achieves a position limiting effect in mounting, and also can ensure that the middle part of the heating element 112 is not in direct contact with the inner wall of the tube 111. In addition, the heat dissipation area can be enlarged to avoid an excessively high temperature at the end of the heating element 112 close to the pointed part 1112.

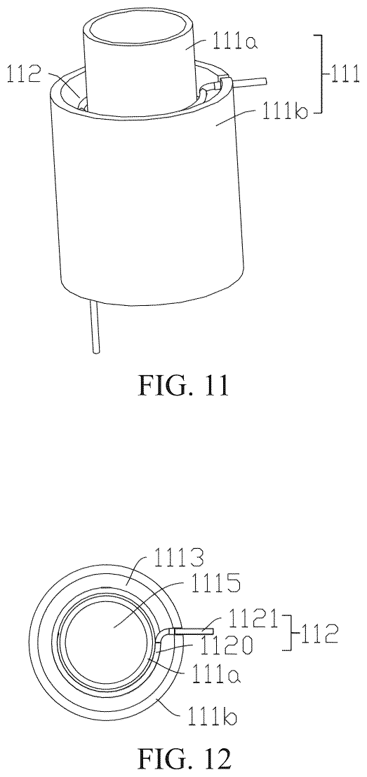

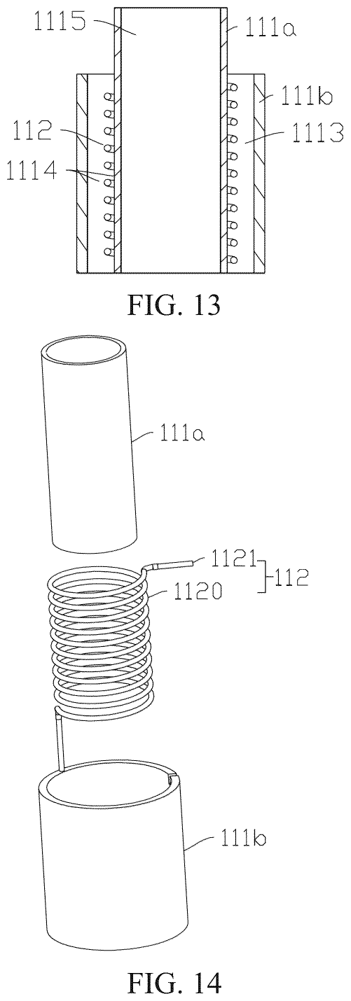

In the aerosol-generating device in some embodiments, as shown in FIG. 11 to FIG. 14, the heating structure 11 is not limited to being partially inserted into the aerosol-forming substrate 200 for heating the aerosol-forming substrate 200. In this embodiment, the outer circumference of a substrate section of the aerosol-forming substrate 200 may be sheathed with the heating structure 11, for heating the aerosol-forming substrate 200 in a circumferential manner. In this embodiment, the tube 111 includes a first tube 111a and a second tube 111b; and the first tube 111a is of a hollow structure with two ends open. The first tube 111a may be cylindrical, and has an inner diameter slightly greater than the outer diameter of the aerosol-forming substrate 200. A second accommodating cavity 1115 may be formed inside the first tube 111a and configured to accommodate the aerosol-forming substrate 200 and form a space for heating the substrate section of the aerosol-forming substrate 200. The axial length of the first tube 111a may be greater than the axial length of the second tube 111b. The outer circumference of the first tube 111a may be sheathed with the second tube 111b. The second tube 111b may be cylindrical, and the radial dimension of the second tube 111b may be greater than the radial dimension of the first tube 111a. Namely, a space is reserved between the second tube 111b and the first tube 111a, and the space may form a first accommodating cavity 1113. The first accommodating cavity 1113 is configured to accommodate the heating element 112. In some embodiments, the heating element 112 is wound around the outer circumference of the first tube 111a, and gaps 1114 are reserved between the entire heating element 112 and both the inner wall of the second tube 111b and the outer wall of the first tube 111a, so that a temperature difference may be formed between the inner wall of the first accommodating cavity 1113 and the heating element 112, to achieve a heat insulation effect. In some embodiments, a reflective layer may be formed on the inner wall of the second tube 111b for reflecting heat from the heating element 112 and radiating the heat to the aerosol-forming substrate 200 to enhance the energy efficiency of heating.

In some other embodiments, the heating element 112 is not necessarily entirely spaced apart from the first tube 111a or the second tube 111b. In some other embodiments, the heating element 112 may be arranged partially spaced apart from the first tube 111a, and the radial dimension of a section of the heating part 1120 may be equivalent to the outer diameter of the first tube 111a, to achieve a position limiting effect. In some embodiments, the heating element 112 may be arranged partially spaced apart from the second tube 111b, and the radial dimension of a section of the heating part 1120 may be equivalent to the radial dimension of the second tube 111b.

Different from a heating element in the prior art, the heating structure 11 heats the aerosol-forming substrate 200 mainly by infrared light waves from the infrared radiation layer 1124, and the heating element 112 assists in heating by heat conduction. As shown in FIG. 7, which is a temperature control curve for heating the aerosol-forming substrate 200, in this solution, the temperature of the heating element 112 may reach 1300° C. to the highest, generally 500-1000° C., preferably 600-800° C. in a steady-state heating process (the local temperature of the heating element in the prior art is about 420° C. to the highest). The tube 111 may have a highest operating temperature of 550° C., a steady-state heating temperature maintained at about 350° C., and a holding temperature maintained at 180-300° C. The infrared radiation layer of the heating element mainly radiates light waves having a wavelength in a range of 2-14 μm, i.e., a waveband range in which the tobacco substrate most easily absorbs, preferably, wavelengths in ranges of 2-4.75 μm and 8-11 μm.

In the prior art, because the highest local temperature of the heating element 112 is 420° C. or lower, a part that is in contact with the aerosol-forming substrate 200 is controlled at about 350° C. (in some cases, the heating element 112 is in direct contact with the aerosol-forming substrate 200, or in some cases, the tube 111 is arranged outside the heating element 112, the heating element 112 is in close contact with the tube 111, and the tube 111 is in contact with the aerosol-forming substrate 200, for heating through heat conduction by physical contact). However, the temperature of the heating element 112 cannot be excessively high. Although temperatures exceeding 420° C. may enable faster aerosol generation from the aerosol-forming substrate 200, but the temperature of the part in contact with the aerosol-forming substrate 200 may also be excessively high. Due to heat conduction by physical contact and high heat capacity of the heating element, the temperature of a rear section may decrease slowly. The aerosol-forming substrate 200 will be burnt inevitably under prolonged exposure to such high temperatures, which also results in a long-lasting contradiction between rapid aerosol generation and consistent flavor experience to be solved effectively. For the heating element 112 in the prior art, because the temperature of the heating element 112 cannot be higher than 420° C., and the heat conduction efficiency by direct physical contact is low, an initial preheating time is relatively long, typically requiring 15 s or longer before normal inhalation. In addition, due to low heat conduction efficiency, the temperature at a holding phase between two puffs cannot be excessively low. Otherwise, the amount of smoke for the next puff may be not enough. Therefore, the holding temperature is high, and an entire cigarette needs to be smoked completely within about 5 min, because the tobacco substrate is substantially completely charred within about 5 min.

In this embodiment, an entire inhalation process may include two main phases:
A preheating phase: the heating element 112 is controlled to heat in a power controlled mode to preheat the aerosol-forming substrate 200. In this step, heating may be started by long-pressing a button on the aerosol-generating device, or heating may be started automatically upon detection of the aerosol-forming substrate 200 being inserted. Moreover, after heating is started, because the temperature measured by a temperature measuring module at this moment exhibits a time lag and cannot truly reflect the inner temperature of the aerosol-forming substrate 200, in the preheating phase, the heating element is controlled to heat at a high power in a power controlled mode. Namely, a processor only controls the magnitude of the heating power and the heating time, for example, controls the heating power to be greater than 10 W and the heating time to be 1-10 s, but does not control the heating element according to the temperature measured by the temperature measuring module. In the preheating phase, the heating element 112 rapidly heats and radiates infrared light for heating. In this process, the highest local temperature of the tube 111 may reach 550° C., so that the preheating temperature of the aerosol-forming substrate 200 may reach 300-400° C. Therefore, the aerosol-forming substrate 200 can be heated to a state capable of aerosol generation in a short time. In the present invention, the high power typically refers to power greater than or equal to 5 W. The preheating time is very short, and rapid aerosol generation is achieved for inhalation within about 3 s typically. The reason is that the heating part 1120 rapidly heats to 500° C. or higher, most of the energy is from infrared light radiated by the heating element 112, with wavelengths concentrated mainly in a range of 2-14 μm, and the tobacco substrate absorbs the radiation energy and rapidly heats up. In addition, part of the energy is heat-transferred to the quartz tube with air as a medium, and after the quartz tube heats up, the heat is transferred to the aerosol-forming substrate 200 (the energy ratio is small in this case). Moreover, part of the energy is radiated in the form of light waves that are then absorbed by the quartz tube for heating. Therefore, the rapid aerosol generation from tobacco is primarily attributable to the fact that the tobacco substrate absorbs the light waves having a wavelength of 2-14 μm and generates heat at an efficiency much higher than that of direct heat conduction. In addition, the heat conduction of the quartz tube also has effects. Therefore, even if the local temperature of the tube 111 reaches 550° C., because the heating time is very short, the heat capacity of the heating element is small, and the heating element is arranged spaced apart from the tube, the temperature of the tube decreases rapidly, and the aerosol-forming substrate is prevented from being burnt. In some embodiments, when the heating element 112 starts heating, the heating rate of the tobacco substrate is higher than that of the quartz tube. Therefore, there is a time period in which the temperature of the tobacco is higher than that of the tube, and there is also a time period in which the temperature of the quartz tube is higher than that of the tobacco. However, with the passage of time, the temperature of the tobacco and the temperature of the quartz tube tend to balance and finally reach about 350° C.
A steady-state heating phase: a temperature detected by the temperature measuring module is obtained, and the heating element 112 is controlled to heat in a temperature controlled mode, to maintain the temperature of the aerosol-forming substrate 200 at the holding temperature. In this step, the preheating phase is followed by a heating phase, and a user may begin inhalation in the heating phase. In addition, because the temperature measured by the temperature measuring module at this moment can truly reflect the inner temperature of the aerosol-forming substrate 200, the heating element 112 may be controlled to heat in the temperature controlled mode according to the temperature detected by the temperature measuring module, to maintain the temperature of the aerosol-forming substrate 200 at the holding temperature in a range of 180-380° C. Specifically, when there is no inhalation, the heating element may be controlled to decrease the temperature by cutting off or reducing the power. When the temperature is decreased to the holding temperature, the heating element is maintained at the holding temperature. Upon detection of the user's inhalation, the temperature of the heating element decreases rapidly. If the temperature decreases rapidly to fall below the holding temperature, the heating element may be controlled to heat until the temperature reaches the holding temperature again, and wait for the next puff. In some embodiments, in the holding phase, the aerosol-forming substrate 200 remains in a state of continuous aerosol generation, i.e., at least one puff of aerosol is pre-stored continuously in this process. When the temperature decreases after inhalation, the pre-stored aerosol is heated, and this process is repeated cyclically. The holding temperature is preferably controlled at 200-330° C. Namely, after the preheating phase, a prompt is given to the user to start inhalation at the 3-second mark. If the user does not start inhalation, a controller controls the heating element 112 to operate at a low power after about 6 s. In this case, because the heat capacity of the heating element 112 is small, after the power is decreased, the temperature of the heating element 112 may decrease rapidly. Also, the energy of the light waves from the heating element 112 that may be absorbed by the tobacco substrate is decreased rapidly. In addition, with the gap between the heating element 112 and the quartz tube, heat conduction is greatly weakened. Therefore, the temperature of the tobacco and the temperature of the quartz tube also decrease rapidly. If inhalation occurs at this moment, cool air from the outside may carry away a large amount of heat, and the temperature of the tobacco and the temperature of the quartz tube may also decrease rapidly. Subsequently, the temperature is kept at a low temperature or increased rapidly to generate an aerosol.

To achieve rapid aerosol production, the heating part 1120 rapidly heats to 500° C. or higher, or even 1000° C. or higher. The light waves whose main wave length is in a range of 2-14 μm may enable the aerosol-forming substrate 200 to generate an aerosol rapidly. Due to the transmittance and uniform heating of the light waves, the aerosol-forming substrate 200 will not be burnt. In addition, due to the gap between the heating element 112 and the quartz tube, the temperature of the contact part between the aerosol-forming substrate 200 and the quartz tube does not increase excessively to burn the aerosol-forming substrate 200. Therefore, the temperature can be increased rapidly without a burnt taste, realizing on-demand inhalation, and ensuring both aerosol volume and flavor. Moreover, due to rapid heating, the holding temperature may be as low as possible, so that consumption of the tobacco substrate is very small in the holding phase. Therefore, the inhalation time of one cigarette may be very long, allowing the user to pause arbitrarily long between two puffs, without compromising sensory experience, thereby reducing limitation to the user and greatly enhancing the experience.

In this embodiment, the user may take inhalations randomly over an extended period without being constrained to complete the inhalations within about 5 min. It should be noted that both the heating temperature and the holding temperature of the aerosol-forming substrate may be represented by the temperature of the tube.

In some embodiments, the heating structure may also be a plasma heating structure. Specifically, a plasma heating structure and a laser heating structure are both central heating structures, i.e., the heating element is at least partially inserted into the aerosol-forming substrate. The so-called plasma structure typically includes a glass tube and two electrodes located in the glass tube. The two electrodes are arranged opposite to each other with a space. After the two electrodes are powered, a high voltage is generated between the electrodes and a gas medium is ionized to generate a high-voltage arc and generate heat. Therefore, the aforementioned method is also applicable to devices having a plasma structure, or other heating structures that heat by light waves and whose operating temperature of a heating element may be 500° C. or higher.

It should be noted that, values in a parameter range set forth in the present invention all include endpoint values in the range. For example, for light waves having a wavelength in a range of 2-14 um, the range includes 2 um, 14 um, and any value therebetween.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for cleaning an aerosol-generating device having a heating structure for heating an aerosol-forming substrate at an operating temperature, the method comprising:
S10: monitoring whether the aerosol-forming substrate is inserted into or extracted from the aerosol-generating device; and
S20: when the aerosol-forming substrate is extracted, setting a temperature of the heating structure to a self-cleaning temperature not exceeding the operating temperature so as to heat and release a material adhered to or deposited on the heating structure.

2. The method of claim 1, wherein step S20 comprises:
S21: when the aerosol-forming substrate is extracted, setting the temperature of the heating structure to the self-cleaning temperature according to a user's input instruction, and heating the material by infrared radiation so as to release the material.

3. The method of claim 2, wherein step S21 comprises:
initiating a first heating mode of the heating structure according to the user's input instruction so as to rapidly increase the temperature of the heating structure to the self-cleaning temperature; and
when the temperature of the heating structure reaches the self-cleaning temperature, adjusting the heating mode of the heating structure and heating the material by infrared radiation so as to release the material.

4. The method of claim 2, wherein the user's input instruction comprises at least one of a mechanical key instruction, a touch key instruction, and a voice instruction.

5. The method of claim 1, wherein step S20 comprises:
S22: determining whether the aerosol-generating device reaches a preset cleaning condition when the aerosol-forming substrate is extracted; and
S23: if the aerosol-generating device reaches the preset cleaning condition, setting the temperature of the heating structure to the self-cleaning temperature, and heating the material by infrared radiation so as to release the material.

6. The method of claim 5, wherein step S23 comprises:
when the aerosol-generating device reaches the preset cleaning condition, initiating a first heating mode of the heating structure so as to rapidly increase the temperature of the heating structure to the self-cleaning temperature; and
when the temperature of the heating structure reaches the self-cleaning temperature, adjusting the heating mode of the heating structure and heating the material by infrared radiation so as to release the material.

7. The method of claim 5, wherein the preset cleaning condition comprises infrared light transmittance of a tube of the heating structure being less than a preset threshold, or
wherein the preset cleaning condition comprises a luster or a color of an outer wall of the tube of the heating structure being in a preset color system.

8. The method of claim 5, wherein the preset cleaning condition comprises a number of aerosol-forming substrates consumed by a user reaching a preset number, or the preset cleaning condition comprises a number of times the aerosol-forming substrates disengage from the heating structure reaching a preset number of times, or
wherein the preset cleaning condition comprises the heating time accumulated since the last cleaning of the heating structure.

9. The method of claim 3, wherein the first heating mode comprises heating at a first preset power for a first preset duration, and
wherein the adjusting the heating mode of the heating structure comprises:
adjusting the first heating mode to at least one of: heating at a constant power for a second preset duration, heating at a variable power for a second preset duration, and pulse heating for a second preset duration.

10. The method of claim 1, wherein the self-cleaning temperature ranges from 400° C. to 550° C.

11. A computer storage medium, storing therein a computer program, which, when executed by a processor, implements the method of claim 1.

12. An aerosol-generating device, comprising:
a processor; and
a memory storing a computer program,
wherein the processor, when executing the computer program, implements the method of claim 1.

13. The aerosol-generating device according to claim 12, wherein a heating structure of the aerosol-generating device comprises a heating element and a tube,
wherein the heating element comprises a heating substrate and an infrared radiation layer arranged on an outer surface of the heating substrate,
wherein the heating substrate is configured to be electrically heated so as to excite the infrared radiation layer to radiate infrared light,
wherein the heating element is arranged at least partially spaced apart from a wall of the tube,
wherein the wall of the tube is configured to allow the infrared light to transmit through, and
wherein the infrared light heats an aerosol-forming substrate.

14. The aerosol-generating device according to claim 13, wherein the heating element is located in the tube, and
wherein at least a part of the tube is configured for insertion of the aerosol-forming substrate.

15. The aerosol-generating device according to claim 13, wherein the heating element is located outside the tube,
wherein an accommodating cavity is formed in the tube, and
wherein the accommodating cavity is configured for accommodating at least a part of the aerosol-forming substrate.

16. The aerosol-generating device according to claim 12, wherein the heating structure of the aerosol-generating device comprises a plasma heating structure.
